(19) United States
(12) Patent Application Publication
(10) Pub. No.: US 2025/0219481 A1
(43) Pub. Date: Jul. 3, 2025

(54) DIRECT DRIVE WHEELS AND INTEGRATED THERMAL RADIATORS FOR A TERRAIN VEHICLE

(71) Applicant: Blue Origin Manufacturing, LLC, Huntsville, AL (US)

(72) Inventors: Wenjiang Yu, Nokesville, VA (US); Carl H. Schell, Issaquah, WA (US)

(21) Appl. No.: 18/402,513

(22) Filed: Jan. 2, 2024

(51) Int. Cl. H02K 1/20; B60K 7/00; H02K 21/14

(52) U.S. Cl. CPC H02K 1/20; H02K 21/14; B60K 2007/0038

(57) ABSTRACT

Systems and methods for cooling an electric motor of a terrain vehicle are presented. In particular, embodiments are directed to cooling an electric drive stator and associated structures of an electric motor of a terrain vehicle. Configurations for such cooling may perform as a local heat radiator, thus avoiding a need for a system that includes pipes, circulating coolant, valves, and pumps for carrying heat to a central radiator. A cooling vessel is in thermal contact with a stator of a motor. The cooling vessel includes various features for dissipating heat collected from the stator or other parts of the motor.

### BACKGROUND

A terrain vehicle, such as a lunar rover, may use one or more electric motors for a drive system (e.g., electric drive). For example, a lunar roving vehicle (LRV) has been used during the last three Apollo missions. The LRV was an electric-drive vehicle designed to operate in the low-gravity vacuum environment of the Moon and to be capable of traversing the lunar surface, allowing the Apollo astronauts to extend the range of their surface extravehicular activities (EVAs). Each wheel of the LRV had its own electric drive, which was a brushed DC electric motor attached to the wheel.

Generally, an electric motor of an electric drive for a vehicle experiences a power loss leading to heat that may need to be radiated away from the motor and the vehicle. For example, the electric drive power loss of an LRV may contribute to about one-third of the total heat that an active cooling system of the LRV may contend with. Heat of an electric motor may arise from the resistance of windings in the motor, core losses, and drive control circuitry, for example. Various techniques for thermal management involve pipes, coolant, valves, and pumps to carry away heat from the electric drive to a central heat radiator where the heat is radiated into space. Such techniques may introduce complications or vulnerabilities to a cooling system. Thus, a demand persists for improved cooling techniques.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic side view of a terrain vehicle, according to some embodiments.

FIG. 2 is a schematic cross-section of a wheel system of a terrain vehicle, according to some embodiments.

FIG. 3 is a schematic cross-section of a wheel system of a terrain vehicle, according to other embodiments.

FIG. 4 is a schematic cross-section of a wheel system of a terrain vehicle, according to still other embodiments.

FIG. 5 is a schematic cross-section of a wheel system of a terrain vehicle, according to yet other embodiments.

FIG. 6 is a schematic cross-section of a wheel system of a terrain vehicle illustrating various configurations for cooling contents in a cooling vessel, according to some embodiments.

### DETAILED DESCRIPTION

This disclosure describes, among other things, systems and methods for cooling an electric motor of a terrain vehicle. In particular, embodiments are directed to cooling an electric drive stator and associated structures of an electric motor of a terrain vehicle. In some of the embodiments, configurations for such cooling may perform as a local heat radiator, thus avoiding a need for a system that includes pipes, circulating coolant, valves, and pumps for carrying heat to a central radiator.

A terrain vehicle, as described in example embodiments herein, may be a vehicle for operating with wheels on Earth, the Moon, Mars, or on any other surface. As described below, the Moon, for example, may present thermal conditions that do not exist on Earth and are beneficial for some of the following electric drive embodiments. Nevertheless, claimed subject matter is not limited to operability on any particular planetary or lunar body.

In general terms, an electric motor is an electrical machine that converts electrical power into mechanical power. Electric motors may operate based on an interaction between the motor's magnetic field (which may be from permanent magnets or electrically generated) and an electric current in wire windings. The interaction generates a rotational force (e.g., torque) applied on a shaft of the motor. Electric motors may be powered by direct current (DC) sources, such as from batteries or rectifiers, or by alternating current (AC) sources, such as a power grid, inverters, or electrical generators. Electric motors may be classified by power source type, construction, application, and type of motion output. For example, generally, an electric motor may be brushed or brushless, single-phase, two-phase, or three-phase, and operate with axial or radial flux. In embodiments herein, claimed subject matter is not limited to any particular type or classification of electric motor.

In some embodiments, a terrain vehicle, such as a rover, transport, carrier, or an automobile, just to name a few examples, may include two or more wheels, wherein four wheels is generally most common. Each wheel may be part of a direct-drive wheel system, which includes the wheel connected to a rotor, a stator configured to magnetically interact with the rotor, and an axle connected to the rotor and the stator. In particular, the axle may be rotationally connected to the stator via a bearing. For example, the axle may rotate with respect to the stator, wherein a bearing that connects the axle and the stator provides the rotational degree of freedom. Thus, the rotor or other part of the wheel may be rigidly connected to the axle. The wheel system may further include a cooling vessel at least partially surrounding, and in thermal contact with, the stator. The cooling vessel may be configured to radiate heat away from the wheel system via various routes, as described below. In some implementations, the cooling vessel may include one or more Peltier elements, which can provide cooling to the cooling vessel via the Peltier effect (e.g., heat energy transfer in response to an applied voltage). The cooling vessel may be substantially empty or contain a liquid, solid, or both. The liquid or solid may provide heat capacity (e.g., heat storage) for heat that dissipates from other parts (e.g., the stator) of the wheel system. In some implementations, the stator may be immersed in a liquid in the cooling vessel. Moreover, a distal portion of the axle may be configured to rotate in the liquid within the cooling vessel. In such implementations, the wheel system may further include one or more blades or rods connected to the distal portion of the axle to desirably stir or agitate the liquid as the axle rotates. Stirring or agitating the liquid may increase the rate of heat dissipating from the wheel system. Another configuration in such implementations may involve one or more magnets attached to a side of the wheel or rotor that is adjacent to the stator and one or more ferrous elements (e.g., balls) disposed in the cooling vessel so as to be substantially magnetically attracted to the one or more magnets. This combination of magnets and ferrous elements may stir or agitate the liquid in the cooling vessel as the wheel and rotor rotates.

In some implementations, the cooling vessel may contain a phase change material (PCM), which provides a relatively large amount of heat storage in the form of its heat capacity (e.g., product of its specific heat value and mass) and its heat of fusion value. The use of PCM may be particularly beneficial on the Moon, which has relatively large temperature swings between night and day. Thus, for example, the PCM may solidify at night when a wheel system is not operating. PCM in its solid state has a relatively high capacity for absorbing and storing heat. When the wheel system is subsequently operating during warmer lunar temperatures of the day, the PCM will be in the desirably solid state.

In some cases, metallic surface features, such as fins, may extend from the cooling vessel. For example, these fins are surfaces that effectively increase the surface area of the cooling vessel to increase the rate of heat transfer away from the cooling vessel (and thus away from the wheel system) by increasing an opportunity for radiation and/or convection to occur. Generally, the amount of conduction, convection, or radiation of an object determines the amount of heat it transfers. Increasing the convective heat transfer coefficient or increasing the surface area of the cooling vessel likely increases the heat transfer. Thus, adding fins to an object, such as the cooling vessel, increases the surface area and heat dissipation. Similarly, fins or rods (or other configuration that increases surface area) may extend from the stator and into liquid that fills the cooling vessel. Accordingly, the fins or rods may improve thermal coupling between the stator and the liquid. In other implementations, fins or rods (or other configuration that increases surface area) may extend from the stator and into PCM that fills the cooling vessel. Accordingly, the fins or rods may improve thermal coupling between the stator and the PCM.

In some implementations, the wheel system may include an external radiator attached to the cooling vessel via tubing. The cooling vessel may radiate at least a portion of the heat away from the wheel system via the external radiator.

In other embodiments, a motor may include a rotor, a stator configured to magnetically interact with the rotor, an axle connected to the rotor and the stator, and a cooling vessel at least partially surrounding, and in thermal contact with, the stator. The cooling vessel may be configured to radiate heat away from the motor. The cooling vessel may contain a liquid and the stator may be immersed in the liquid. The axle may be connected to the stator via a bearing and a distal portion of the axle may be configured to rotate in the liquid within the cooling vessel. In such an implementation, one or more blades or rods may be connected to the distal portion of the axle to stir or agitate the liquid when the axle rotates.

The motor may also include one or more magnets attached to a side of the rotor that is adjacent to the stator and one or more ferrous elements disposed in the cooling vessel so as to be substantially magnetically attracted to the one or more magnets. Such an arrangement may stir or agitate the liquid when the rotor rotates.

In other implementations, the cooling vessel may contain a PCM. Metallic surface features may extend from the stator and into the PCM to thermally couple the stator with the PCM.

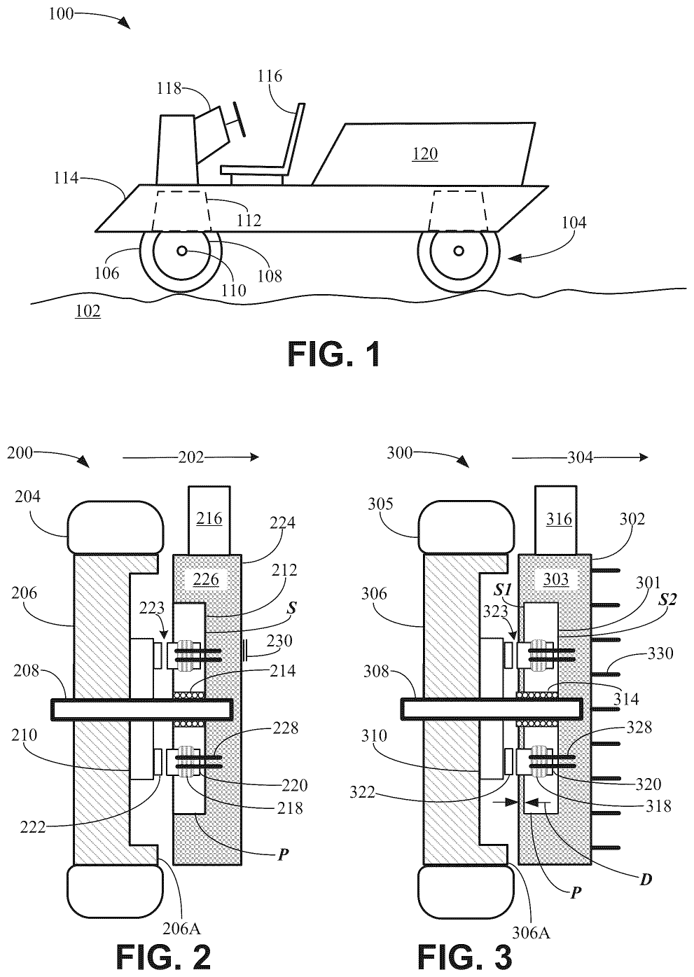

FIG. 1 is a schematic side view of a terrain vehicle 100 on a planetary or lunar surface 102, according to some embodiments. Terrain vehicle 100, as mentioned above, may be a rover, transport, carrier, or an automobile, just to name a few examples. Though claimed subject matter is not so limited, terrain vehicle 100 includes four wheel systems 104. Each wheel system may comprise a tire 106 mounted on a rim 108 that is connected to an axle 110. Though not illustrated in FIG. 1, each wheel system 104 may also include a rotor mounted to rim 108 and/or axle 110. As explained below, the rotor is part of a motor that imparts a torque to tire 106 and rim 108. Also not illustrated in FIG. 1, the motor includes a stator to which axle 110 is connected, though in some implementations axle 110 may be connected to an infrastructure, such as a suspension system 112 of chassis 114, of terrain vehicle 100. The connection may be via a bearing that provides a rotational degree of freedom of axle 110 with respect to suspension system 112.

Terrain vehicle 100 may also include an operator's seat 116, a control console 118, and a portion 120 that may include storage, heat dissipation radiators, communications equipment, control electronics/avionics, and batteries, just to name a few examples. Claimed subject matter is not limited to any particular terrain vehicle configuration, location of operation, or functionality. For example, terrain vehicle 100 may be an excavator designed to operate on the Moon or an automobile to be driven on terrestrial roadways.

FIG. 2 is a schematic cross-section of a wheel system 200 of a terrain vehicle, according to some embodiments. For example, wheel system 200 may be the same as or similar to 104 and the terrain vehicle may be terrain vehicle 100, described above. For general orientation, arrow 202 points toward a central part of the terrain vehicle. In other implementations, however, arrow 202 may point toward the exterior of the terrain vehicle. In these implementations, portions of wheel system 200 that tend to build up the most heat can be exposed to the outside of the terrain vehicle for improved heat dissipation, as compared to these portions of the wheel system facing inward toward the central part of the terrain vehicle, for example. Wheel system 200 may include a tire 204 mounted on a rim 206 that is connected to an axle 208. As illustrated, rim 206 may include a wide portion 206A that is on an outer perimeter of the rim. Wheel system 200 may also include a rotor 210 mounted to rim 206 and/or axle 208. The rotor is part of a motor that imparts a torque to axle 208. The motor includes a stator 212 to which axle 208 may be connected via a bearing 214 that provides a rotational degree of freedom to axle 208 with respect to the terrain vehicle. In some implementations, in addition to, or instead of, being connected to stator 212, axle 208 may be connected to an infrastructure, such as a suspension system 216, of the terrain vehicle. For clarity of illustration, such a connection is not illustrated in detail in FIG. 2. Though FIG. 2 illustrates axle 208 extending past stator 212, claimed subject matter is not limited in this respect. For example, axle 208 may terminate within, at, or just beyond stator 212.

As mentioned above, an electric motor operates, in general terms, based on an interaction between the motor's magnetic field and an electric current in a wire winding. Accordingly, stator 212 is configured to magnetically interact with rotor 210 to impart a torque to the rotor. FIG. 2 illustrates a particular type of motor wherein stator 212 includes wire windings 218 around a ferromagnetic core 220 (e.g., iron) to produce a magnetic field that interacts with magnets 222 mounted on rotor 210. A gap 223 separates the stator and the rotor.

Wheel system 200 also includes a cooling vessel 224 that may enclose a volume 226 to hold a liquid, a solid, or a combination thereof. In some implementations, cooling vessel 224 may contain a PCM. Cooling vessel 224 is in thermal contact with stator 212. As illustrated, such thermal contact may be on a side S and a perimeter P of stator 212. A primary function of cooling vessel 224 is to provide a thermal path for heat generated in the motor to leave wheel system 200. For example, during operation of the wheel system, wire windings 218 and ferromagnetic core 220 of the stator may generate heat that may be removed by cooling vessel 224 by heat sinking in volume 226 and/or by radiating the heat from the exterior surfaces of the cooling vessel. In particular, cooling vessel 224 may absorb heat from the stator by heating and melting a PCM in volume 226 or by heating a liquid or solid in volume 226. To improve heat removal from the stator, cooling vessel 224 may be made of a metal having a relatively high thermal conductivity, such as aluminum, for example. Additionally, thermally conductive rods 228 may extend from windings 218 and/or ferromagnetic core 220 of the stator into the material (e.g., PCM, liquid, or solid) in volume 226. In some implementations, cooling vessel 224 may include one or more Peltier elements 230, which can provide cooling to the cooling vessel via the Peltier effect.

FIG. 3 is a schematic cross-section of a wheel system 300 of a terrain vehicle, according to some embodiments. For example, wheel system 300 may be the same as or similar to 200 except for, among other things, relative positioning of a cooling vessel with respect to a stator, as described below. In particular, a stator 301 is inside a cooling vessel 302, wherein a volume 303 inside the cooling vessel may extend a distance D from the stator to the inside surface of the cooling vessel. In this way, cooling vessel 302 may be in thermal contact with stator 301 on sides S1, S2, and a perimeter P of stator 301. Thus, a liquid, a solid, or a PCM may surround the stator for additional cooling of the stator, as compared to the positioning of stator 212 in wheel system 200, for example.

For general orientation, arrow 304 points toward a central part of the terrain vehicle. In other implementations, however, arrow 304 may point toward the exterior of the terrain vehicle. In these implementations, portions of wheel system 300 that tend to build up the most heat can be exposed to the outside of the terrain vehicle for improved heat dissipation, as compared to these portions of the wheel system facing inward toward the central part of the terrain vehicle, for example. Wheel system 300 may include a tire 305 mounted on a rim 306 that is connected to an axle 308. As illustrated, rim 306 may include a wide portion 306A that is on an outer perimeter of the rim. Wheel system 300 may also include a rotor 310 mounted to rim 306 and/or axle 308. The rotor is part of a motor that imparts a torque to axle 308. The motor includes stator 301 to which axle 308 may be connected via a bearing 314 that provides a rotational degree of freedom to axle 308 with respect to the terrain vehicle. In some implementations, in addition to, or instead of, being connected to stator 301, axle 308 may be connected to an infrastructure, such as a suspension system 316, of the terrain vehicle. For clarity of illustration, such a connection is not illustrated in detail in FIG. 3. Though FIG. 3 illustrates axle 308 extending past stator 301, claimed subject matter is not limited in this respect. For example, axle 308 may terminate within, at, or just beyond stator 301.

Stator 301 is configured to magnetically interact with rotor 310 to impart a torque to the rotor. FIG. 3 illustrates a particular type of motor wherein stator 301 includes wire windings 318 around a ferromagnetic core 320 (e.g., iron) to produce a magnetic field that interacts with magnets 322 mounted on rotor 310. A gap 323, the same as or similar to 223, separates the stator and the rotor.

In some implementations, cooling vessel 302 may contain a PCM. A primary function of cooling vessel 302 is to provide a thermal path for heat generated in the motor to leave wheel system 300. For example, during operation of the wheel system, wire windings 318 and ferromagnetic core 320 of the stator may generate heat that may be removed by cooling vessel 302 by heat sinking in volume 303 and/or by radiating the heat from the exterior surfaces of the cooling vessel. In particular, cooling vessel 302 may absorb heat from the stator by heating and melting a PCM in volume 303 or by heating a liquid or solid in volume 303. To improve heat removal from the stator, cooling vessel 302 may be made of a metal having a relatively high thermal conductivity, such as aluminum for example. Additionally, thermally conductive rods 328 may extend from windings 318 and/or ferromagnetic core 320 of the stator into the material (e.g., PCM, liquid, or sold) in volume 303. Thermally conductive rods 328 may be copper or aluminum, for example. In some implementations, metallic surface features, such as fins 330, may extend from cooling vessel 302 in a direction away from wheel system 300. For example, fins 330 may be surfaces that effectively increase the surface area of cooling vessel 302 to increase the rate of heat transfer away from the cooling vessel (and thus away from the wheel system) by increasing an opportunity for radiation and/or convection to occur (e.g., depending on whether wheel system 300 is operating in a vacuum or an atmosphere). Thus, cooling vessel 302 may dissipate at least some heat away from the wheel system via fins 330, which may be spaced apart and sized in an unlimited way with respect to claimed subject matter. Fins 330 may be produced by extrusion, casting, or milling, for example.

Embodiments 200 and 300 described above may involve an axial flux permanent magnet (AFPM) motor, which is a particular type of electric motor that includes a rotor and a stator. As previously mentioned, claimed subject matter is not limited with respect to electric motor type. For example, with some changes to configuration, embodiments 200 and 300 may involve a different type of electric motor. Embodiments described below may involve a type of electric motor, such as an axial flux reluctance motor, which is different from those illustrated in FIGS. 2 and 3, for example.

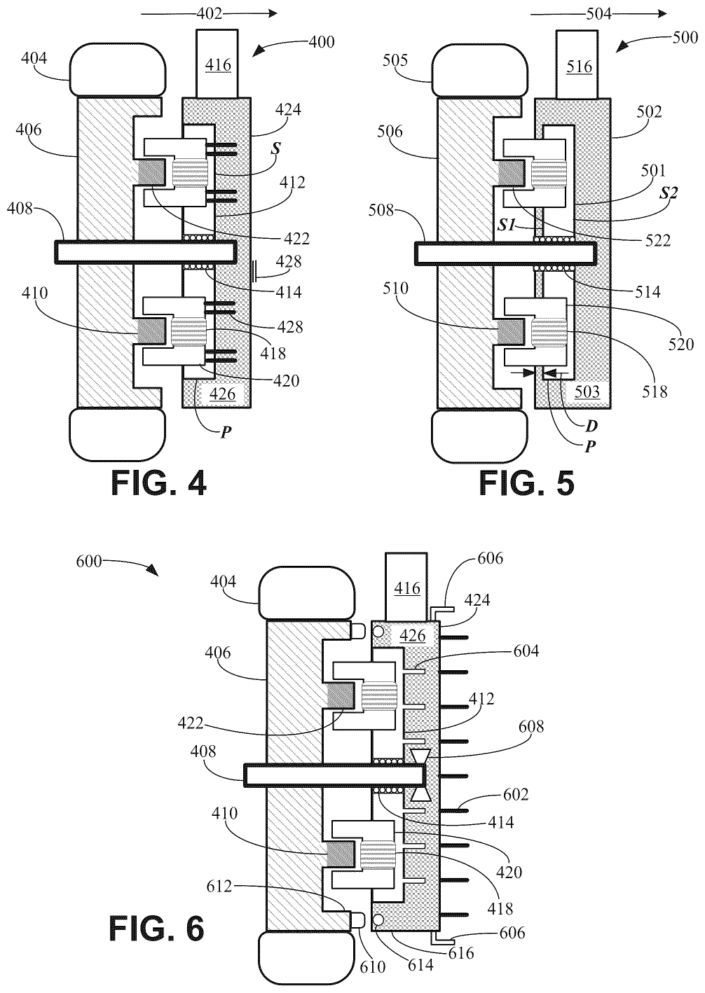

FIG. 4 is a schematic cross-section of a wheel system 400 of a terrain vehicle, according to some embodiments. For example, wheel system 400 may be the same as or similar to 104 and the terrain vehicle may be terrain vehicle 100, described above. For general orientation, arrow 402 points toward a central part of the terrain vehicle. In other implementations, however, arrow 402 may point toward the exterior of the terrain vehicle. In these implementations, portions of wheel system 400 that tend to build up the most heat can be exposed to the outside of the terrain vehicle for improved heat dissipation, as compared to these portions of the wheel system facing inward toward the central part of the terrain vehicle, for example. Wheel system 400 may include a tire 404 mounted on a rim 406 that is connected to an axle 408. Wheel system 400 may also include a rotor 410 attached to rim 406 and/or axle 408. The rotor is part of a motor that imparts a torque to axle 408. The motor includes a stator 412 to which axle 408 may be connected via a bearing 414 that provides a rotational degree of freedom to axle 408 with respect to the terrain vehicle. In some implementations, in addition to, or instead of, being connected to stator 412, axle 408 may be connected to an infrastructure, such as a suspension system 416, of the terrain vehicle. To maintain clarity of the illustration, such a connection is not illustrated in detail in FIG. 4. Though FIG. 4 illustrates axle 408 extending past stator 412, claimed subject matter is not limited in this respect. For example, axle 408 may terminate within, at, or just beyond stator 412.

Stator 412 is configured to magnetically interact with rotor 410 to impart a torque to the rotor. FIG. 4 illustrates a particular type of motor wherein stator 412 includes wire windings 418 around a ferromagnetic core 420 (e.g., iron) to produce a magnetic field that interacts with ferromagnetic material 422 on rotor 410.

Wheel system also includes a cooling vessel 424 that may enclose a volume 426 to hold a liquid, a solid, or a combination thereof. In some implementations, cooling vessel 424 may contain a PCM. Cooling vessel 424 may be in thermal contact with stator 412. As illustrated, such thermal contact may be on a side S and a perimeter P of stator 412. A primary function of cooling vessel 424 is to provide a thermal path for heat generated in the motor to leave wheel system 400. For example, during operation of the wheel system, wire windings 418 and ferromagnetic core 420 of the stator may generate heat that may be removed by cooling vessel 424 by heat sinking in volume 426 and/or by radiating the heat from the exterior surfaces of the cooling vessel. In particular, cooling vessel 424 may absorb heat from the stator by heating and melting a PCM in volume 426 or by heating a liquid or solid in volume 426. To improve heat removal from the stator, cooling vessel 424 may be made of a metal having a relatively high thermal conductivity, such as aluminum, for example. Additionally, thermally conductive rods 428 may extend from windings 418 and/or ferromagnetic core 420 of the stator into the material (e.g., PCM, liquid, or solid) in volume 426. In some implementations, cooling vessel 424 may include one or more Peltier elements 428, which can provide cooling to the cooling vessel via the Peltier effect.

FIG. 5 is a schematic cross-section of a wheel system of a terrain vehicle, according to yet other embodiments. For example, wheel system 500 may be the same as or similar to 400 except for, among other things, relative positioning of a cooling vessel with respect to a stator, as described below. In particular, a stator 501 is inside a cooling vessel 502, wherein a volume 503 may extend a distance D from the stator to the inside surface of the cooling vessel. In this way, cooling vessel 502 may be in thermal contact with stator 501 on sides S1, S2, and a perimeter P of stator 501. Thus, a liquid, a solid, or a PCM may surround the stator for additional cooling of the stator, as compared to the positioning of stator 412 in wheel system 400, for example.

For general orientation, arrow 504 points toward a central part of the terrain vehicle. In other implementations, however, arrow 504 may point toward the exterior of the terrain vehicle. In these implementations, portions of wheel system 500 that tend to build up the most heat can be exposed to the outside of the terrain vehicle for improved heat dissipation, as compared to these portions of the wheel system facing inward toward the central part of the terrain vehicle, for example. Wheel system 500 may include a tire 505 mounted on a rim 506 that is connected to an axle 508. Wheel system 500 may also include a rotor 510 mounted to rim 506 and/or axle 508. The rotor is part of a motor that imparts a torque to axle 508. The motor includes stator 501 to which axle 508 may be connected via a bearing 514 that provides a rotational degree of freedom to axle 508 with respect to the terrain vehicle. In some implementations, in addition to, or instead of, being connected to stator 501, axle 508 may be connected to an infrastructure, such as a suspension system 516, of the terrain vehicle. For clarity of illustration, such a connection is not illustrated in detail in FIG. 5. Though FIG. 5 illustrates axle 508 extending past stator 501, claimed subject matter is not limited in this respect. For example, axle 508 may terminate within, at, or just beyond stator 501.

Stator 501 is configured to magnetically interact with rotor 510 to impart a torque to the rotor. FIG. 5 illustrates a particular type of motor wherein stator 501 includes wire windings 518 around a ferromagnetic core 520 (e.g., iron) to produce a magnetic field that interacts with ferromagnetic material 522 mounted on rotor 510.

In some implementations, cooling vessel 502 may contain a PCM. A primary function of cooling vessel 502 is to provide a thermal path for heat generated in the motor to leave wheel system 500. For example, during operation of the wheel system, wire windings 518 and ferromagnetic core 520 of the stator may generate heat that may be removed by cooling vessel 502 by heat sinking in volume 503 and/or by radiating the heat from the exterior surfaces of the cooling vessel. In particular, cooling vessel 502 may absorb heat from the stator by heating and melting a PCM in volume 503 or by heating a liquid or solid in volume 503. To improve heat removal from the stator, cooling vessel 502 may be made of a metal having a relatively high thermal conductivity, such as aluminum for example.

FIG. 6 is a schematic cross-section of wheel system 600 illustrating various possible configurations for cooling contents, such as a liquid, solid, or PCM, in cooling vessel 424, according to some embodiments. Wheel system 600 may be the same as or similar to 400, described above, with the addition of various features. For example, metallic surface features, such as fins 602, may extend from cooling vessel 424 in a direction away from the wheel system. Fins 602 may be surfaces that effectively increase the surface area of the cooling vessel to increase the rate of heat transfer away from the cooling vessel (and thus away from the wheel system) by increasing an opportunity for radiation and/or convection to occur (e.g., depending on whether wheel system 600 is operating in a vacuum or an atmosphere). Thus, cooling vessel 424 may dissipate at least some heat away from the wheel system via fins 602, which may be spaced apart and sized in an unlimited way with respect to claimed subject matter. Fins 602 may be produced by extrusion, casting, or milling, for example.

In some implementations, thermally conductive rods or metallic surface features, such as fins 604, may extend from stator 412 into volume 426, which may contain liquid, solid, or PCM, for example. Fins 604 may be surfaces that effectively increase the surface area of the stator to increase the rate of heat transfer away from the stator by increasing an opportunity for heat conduction into volume 426 to occur. Fins 604 may be produced by extrusion, casting, or milling of the stator, or may be aluminum or copper rods, for example, attached to the stator.

In some implementations, an external radiator (not illustrated) may be included in wheel system 600 to increase cooling ability. The external radiator may be attached to cooling vessel 424 via tubing 606 that is configured to carry liquid in volume 426, for instance. The cooling vessel may radiate at least a portion of the heat generated in the stator, for example, away from the wheel system via the external radiator.

As mentioned above, stirring or agitating a liquid in cooling vessel 424 may increase the rate of heat dissipating from the wheel system. For example, such stirring or agitating, in addition to natural thermal convection currents, allows the liquid to circulate against the surfaces of stator 412 so as to enable relatively efficient heat conduction (e.g., by maximizing local temperature deltas (and thus heat transfer) between the stator and liquid). Some of the following implementations involve features that stir or agitate liquid in cooling vessel 424.

In one implementation, a distal portion of axle 408 may be configured to rotate in the liquid within cooling vessel 424 by extending past stator 412 and through a liquid-tight seal in a side of the cooling vessel. One or more blades or rods 608 may be connected to the distal portion of the axle to desirably stir or agitate the liquid as the axle rotates.

Another implementation involves one or more magnets attached to a side of the rim or rotor that is adjacent to the stator and one or more ferrous elements disposed in the cooling vessel so as to be substantially magnetically attracted to the one or more magnets. This combination of magnets and ferrous elements may stir or agitate the liquid in the cooling vessel as the wheel or rotor rotates. For example, rim 406 or rotor 410 may include magnets 610 affixed thereon. Rim 406 may include a wide portion 612 (e.g., similar to 206A and 306A) that is on an outer perimeter of the rim. A distal edge of the wide portion, where magnets 610 are located, may be relatively close to a portion of cooling vessel 424. Ferrous balls 614 placed in the cooling vessel may be magnetically attracted to magnets 610 if balls 614 are relatively close to the magnets and cooling vessel 424 is made out of a nonferrous material, such as aluminum or copper, for example. Accordingly, as magnets 610 revolve around axle 408 with the rotation of the wheel and rotor, corresponding balls 614 may follow along on the inside surface of cooling vessel 424. The motion of the balls in the liquid may stir and/or agitate the liquid. Perimeter side 616 may be sloped slightly so that balls 614 are gravity-driven toward magnets 610 if the balls end up in another part of volume 426, which may happen if the liquid experiences chaotic agitation, for example.

Though the features that involve blades or rods 606, magnets 608, an exterior radiator, Peltier elements (e.g., 230 and 428), fins 602, and fins 604 are illustrated and described for wheel system 600, any or all of such features may be included in other wheel systems described herein, such as wheel systems 104, 200, 300, and 500.

The foregoing description, for purposes of explanation, uses specific nomenclature to provide a thorough understanding of the disclosure. It will be apparent to one skilled in the art, however, that specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are illustrated and described to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A wheel system of a terrain vehicle, the wheel system comprising:
a wheel connected to a rotor;
a stator configured to magnetically interact with the rotor;
an axle connected to the rotor and the stator, wherein the axle is rotationally connected to the stator; and
a cooling vessel at least partially surrounding, and in thermal contact with, the stator, wherein the cooling vessel is configured to radiate heat away from the wheel system.

2. The wheel system of claim 1, wherein the cooling vessel contains a liquid.

3. The wheel system of claim 2, wherein the stator is immersed in the liquid in the cooling vessel.

4. The wheel system of claim 2, wherein the axle is rotationally connected to the stator via a bearing and wherein a distal portion of the axle is configured to rotate in the liquid within the cooling vessel, the wheel system further comprising:
one or more blades or rods connected to the distal portion of the axle to stir or agitate the liquid when the axle rotates.

5. The wheel system of claim 2, further comprising:
one or more magnets attached to a side of the wheel or rotor that is adjacent to the stator; and
one or more ferrous elements disposed in the cooling vessel so as to be substantially magnetically attracted to the one or more magnets and to stir or agitate the liquid when the wheel or rotor rotates.

6. The wheel system of claim 1, wherein the cooling vessel contains a phase change material.

7. The wheel system of claim 1, wherein the cooling vessel includes one or more Peltier elements.

8. The wheel system of claim 1, further comprising heat fins that extend from the cooling vessel, wherein the cooling vessel radiates at least a portion of the heat away from the wheel system via the heat fins.

9. The wheel system of claim 1, further comprising an external radiator attached to the cooling vessel via tubing, wherein the cooling vessel radiates at least a portion of the heat away from the wheel system via the external radiator.

10. The wheel system of claim 2, further comprising metallic surface features that extend from the stator and into the liquid to thermally couple the stator with the liquid.

11. The wheel system of claim 10, wherein the metallic surface features are heat fins or rods.

12. The wheel system of claim 6, further comprising metallic surface features that extend from the stator and into the phase change material to thermally couple the stator with the phase change material.

13. The wheel system of claim 12, wherein the metallic surface features are heat fins or rods.

14. A motor comprising:
a rotor;
a stator configured to magnetically interact with the rotor;
an axle connected to the rotor and the stator; and
a cooling vessel at least partially surrounding, and in thermal contact with, the stator, wherein the cooling vessel is configured to radiate heat away from the motor.

15. The motor of claim 14, wherein the cooling vessel contains a liquid.

16. The motor of claim 15, wherein the stator is immersed in the liquid in the cooling vessel.

17. The motor of claim 15, wherein the axle is connected to the stator via a bearing and wherein a distal portion of the axle is configured to rotate in the liquid within the cooling vessel, the motor further comprising:
one or more blades or rods connected to the distal portion of the axle to stir or agitate the liquid when the axle rotates.

18. The motor of claim 15, further comprising:
one or more magnets attached to a side of the rotor that is adjacent to the stator; and
one or more ferrous elements disposed in the cooling vessel so as to be substantially magnetically attracted to the one or more magnets and to stir or agitate the liquid when the rotor rotates.

19. The motor of claim 14, wherein the cooling vessel contains a phase change material.

20. The motor of claim 19, further comprising metallic surface features that extend from the stator and into the phase change material to thermally couple the stator with the phase change material.
